(19) United States
(12) Patent Application Publication
(10) Pub. No.: US 2026/0056327 A1
(43) Pub. Date: Feb. 26, 2026

(54) METHOD FOR IMPROVING MULTI-GPS ACCURACY AND VEHICLE CONTROL MANAGEMENT SYSTEM USING THE SAME

(71) Applicant: KKUN, Jeonbuk-do (KR)

(72) Inventors: BYEONG CHAN SIM, Seoul (KR); SEOK SU HAN, Seoul (KR)

(21) Appl. No.: 19/293,065

(22) Filed: Aug. 7, 2025

(30) Foreign Application Priority Data
Aug. 23, 2024 (KR) 10-2024-0113448

(51) Int. Cl. G01S 19/09; G01S 19/40

(52) U.S. Cl. CPC G01S 19/09; G01S 19/40

(57) ABSTRACT

A vehicle control management system collecting operation information of multiple vehicles to control each vehicle includes, when collecting operation information of a vehicle, a vehicle information collection unit that collects each GPS coordinate from multiple GPS terminals inside the vehicle; and when receiving the operation information of the vehicle information collection unit through a wireless communication network, control server that aligns all received GPS coordinates in a vehicle-based time sequence, but aligns the GPS coordinates by excluding GPS coordinates that are out of a predetermined range, and simplifies the GPS coordinates by applying a preset GPS information simplification algorithm.

### CROSS-REFERENCE TO RELATED APPLICATION AND CLAIM OF PRIORITY

This application claims the benefit under 35 USC § 119 of Korean Patent Application No. 10-2024-0113448, filed on Aug. 23, 2024, in the Korean Intellectual Property Office, the entire disclosure of which is incorporated herein by reference for all purposes.

### BACKGROUND

### 1. Technical Field

The present disclosure relates to a vehicle control management system, and more particularly, to a method for improving multi-GPS accuracy and a vehicle control management system using the same.

### 2. Background of the Invention

In order to efficiently operate a vehicle control management system that processes logistics, charging, cargo management, delivery, etc., it is necessary to accurately identify operation information of each vehicle. In particular, it is most important to accurately identify a location of each vehicle among the operation information of the vehicle.

A navigation device is a type of vehicle automatic navigation device designed for use in automobiles. A main purpose of the navigation device is to guide a route to a destination entered by a user by identifying a current location of a vehicle using a GPS module (GPS receiver). The navigation device is recognized as an essential device for vehicle operation by providing various additional functions and conveniences such as guidance on traffic signal violation crackdown sections, speeding crackdown sections, nearby gas stations guidance, and real-time traffic situation guidance.

However, since navigation (NAVI) uses GPS signals transmitted from GPS satellites, the NAVI may not perform normal reception in places where the sky is obscured. For example, when a user tries to receive in an indoor or underground parking lot, a forested area, etc., a current location of the user will not be recognized, so he/she should move to an outdoor area with good satellite reception and try to receive again.

The GPS signals transmitted from the GPS satellites may not be received normally indoors, in tunnels, underpasses, elevated roads, or in areas with many tall buildings (in apartment complexes, and areas with densely packed tall buildings). When a vehicle is parked in a shaded area, such as an underground or indoor parking lot, for a long time, the GPS signal is blocked, and the current location may not be calculated. Accordingly, when the vehicle moves to an area with good reception, the GPS signal is received, and the current location is recognized.

In order to overcome the inaccuracy of such GPS location information, attempts have been made to improve the accuracy of location by additionally using camera shooting information, etc., but there is a disadvantage in that a large geographic information database should be built in advance to use the camera shooting information, and periodic geographic information updates are required.

### SUMMARY

The present disclosure has been proposed to solve the above technical problem, and provides a vehicle control management system for improving multi-GPS accuracy by collecting each GPS coordinate from multiple GPS terminals of a vehicle and applying a preset GPS information simplification algorithm to simplify GPS coordinates.

In one general aspect, a method for improving multi-GPS accuracy includes: receiving, by a control server, each GPS coordinate from multiple GPS terminals of a vehicle; aligning, by the control server, all received GPS coordinates in vehicle-based time sequence, but excluding the GPS coordinates that are out of a predetermined range; and simplifying, by the control server, the GPS coordinates by applying a preset GPS information simplification algorithm to simplify the GPS coordinates to remove coordinates that are out of the predetermined range and reduce the number of coordinates.

The GPS information simplification algorithm may selectively use “Ramer-Douglas-Peucker algorithm” as a first algorithm and “LANG” as a second algorithm.

The multiple GPS terminals may include at least one of a smartphone, a vehicle navigation terminal, and a vehicle black box terminal.

In the aligning, coordinates that are out of a road range based on geographic information may be excluded from among all the received GPS coordinates.

In the aligning, the coordinates that are out of the predetermined range may be excluded by applying a regression analysis model or machine learning to all the received GPS coordinates.

In another general aspect, a vehicle control management system collecting operation information of multiple vehicles to control each vehicle includes: when collecting operation information of a vehicle, a vehicle information collection unit that collects each GPS coordinate from multiple GPS terminals inside the vehicle; and when receiving the operation information of the vehicle information collection unit through a wireless communication network, a control server that aligns all received GPS coordinates in a vehicle-based time sequence, but aligns the GPS coordinates by excluding GPS coordinates that are out of a predetermined range, and simplifies the GPS coordinates by applying a preset GPS information simplification algorithm.

The vehicle control management system may further include: a consumer terminal that includes a consumer application installed for processing a service provided by accessing the control server; and a transportation driver terminal that has a transportation driver application installed for processing the service provided by accessing the control server.

The GPS information simplification algorithm may selectively use “Ramer-Douglas-Peucker algorithm” as a first algorithm and “LANG” as a second algorithm.

The multiple GPS terminals may include at least one of a smartphone, a vehicle navigation terminal, and a vehicle black box terminal.

The control server may exclude coordinates that are out of a road range based on geographic information from among all the received GPS coordinates.

The control server may exclude the coordinates that are out of the predetermined range by applying a regression analysis model or machine learning to all the received GPS coordinates.

As described above, according to the vehicle control management system of the present disclosure, by collecting the GPS coordinates from the multiple GPS terminals of the vehicle and applying the preset GPS information simplification algorithm to simplify the GPS coordinates, it is possible to improve the multi-GPS accuracy, and efficiently process the logistics, charging, cargo management, delivery, etc.

### BRIEF DESCRIPTION OF THE DRAWINGS

FIG. 1 is a conceptual diagram of a vehicle control management system 1 for improving multi-GPS accuracy of the present disclosure.

FIG. 2 is a configuration diagram of the vehicle control management system 1 for improving multi-GPS accuracy according to an embodiment of the present disclosure.

FIG. 3 is a flowchart of a method for improving multi-GPS accuracy processed in the vehicle control management system for improving multi-GPS accuracy of the present disclosure.

FIG. 4 is a flowchart of the method for improving multi-GPS accuracy according to an embodiment.

FIG. 5 is an exemplary diagram for managing inter-vehicle linked delivery.

FIG. 6 is an exemplary diagram for managing matching between linked delivery and a charger.

FIG. 7 is an exemplary diagram for performing management by reflecting variables such as traffic conditions and weather.

### DETAILED DESCRIPTION OF EMBODIMENTS

Hereinafter, embodiments of the present disclosure will be described in detail with reference to the accompanying drawings so that those skilled in the art may easily implement the spirit of the present disclosure.

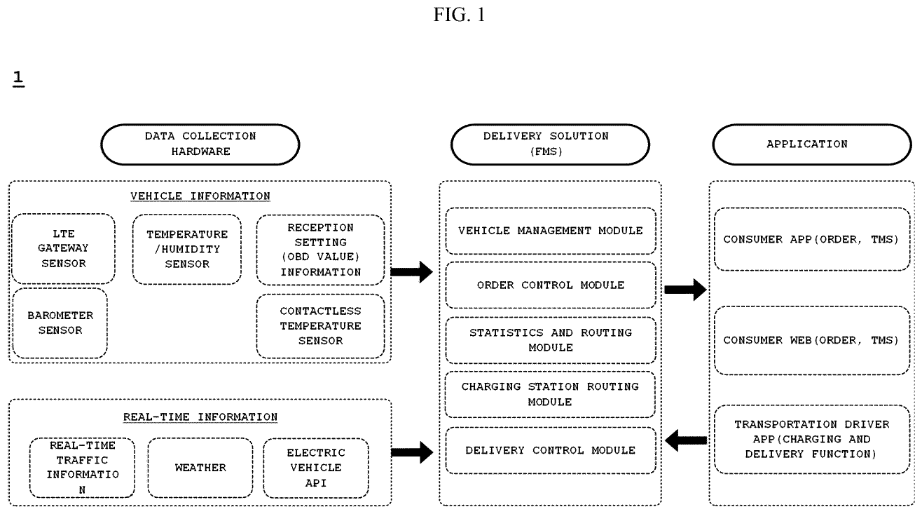

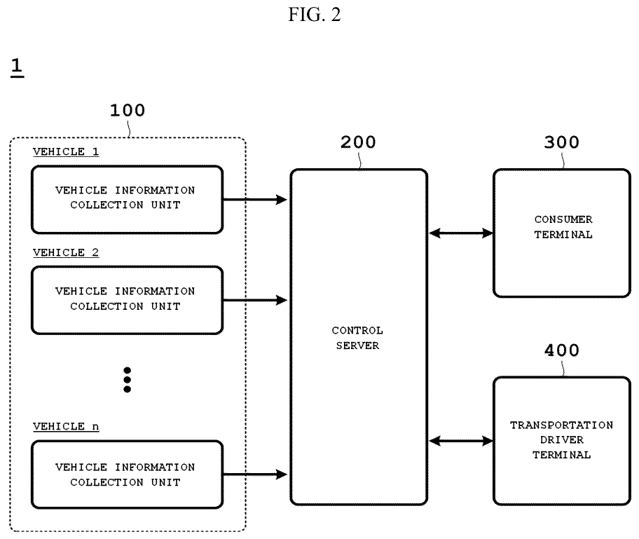

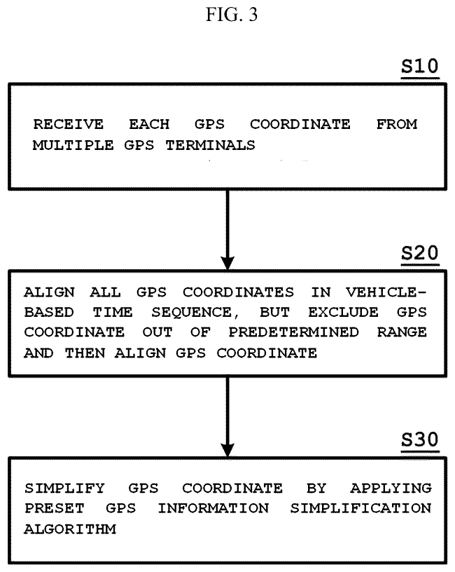

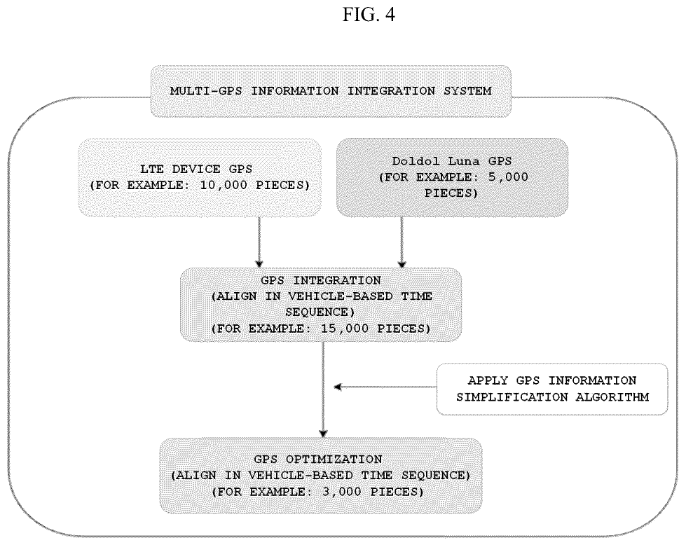

FIG. 1 is a conceptual diagram of a vehicle control management system 1 for improving multi-GPS accuracy of the present disclosure, FIG. 2 is a configuration diagram of the vehicle control management system 1 for improving multi-GPS accuracy according to an embodiment of the present disclosure, FIG. 3 is a flowchart of a method for improving multi-GPS accuracy processed in the vehicle control management system for improving multi-GPS accuracy of the present disclosure, and FIG. 4 is a flow chart of a method for improving multi-GPS accuracy according to an embodiment.

The vehicle control management system 1 according to the present embodiment includes only a brief configuration for clearly describing the technical idea to be proposed.

Referring to FIGS. 1 to 4, the vehicle control management system 1 is configured to include a data collection unit 100, a control server 200, a consumer terminal 300, and a transportation driver terminal 400.

The main operations of the vehicle control management system 1 configured as described above are as follows.

The vehicle control management system 1 of the present disclosure is a management system that processes logistics, charging, cargo management, delivery, etc., and in order to efficiently operate tasks linked to vehicles, it is most important to accurately identify a location of each vehicle among the operation information of each vehicle.

That is, the vehicle control management system 1 collects operation information of multiple vehicles, and supports a specific service while controlling each vehicle. In order to accurately identify the location of each vehicle, the vehicle control management system 1 processes the following operations.

The vehicle information collection unit 100 collects information such as communication status, air pressure, temperature and humidity, and vehicle status and transmits the collected information to the control server 200. In particular, the vehicle information collection unit 100 collects each GPS coordinate from multiple GPS terminals of the vehicle and transmits the GPS coordinates to the control server 200.

Here, the multiple GPS terminals include at least one of a smartphone, a vehicle navigation terminal, and a vehicle black box terminal. In addition, according to the embodiment, the GPS coordinates built into a terminal equipped for delivery or a specific service may be additionally used.

The control server 200 receives operation information from the vehicle information collection unit 100 through a wireless communication network such as LTE, 3G, or 5G, and processes an operation of aligning all received GPS coordinates in a vehicle-based time sequence, but excluding the GPS coordinates that are out of a predetermined range, and applying a preset GPS information simplification algorithm to simplify the GPS coordinates. The GPS information simplification algorithm is applied to remove coordinates that are out of a predetermined range and reduce the number of coordinates.

That is, the control server 200 excludes coordinates that are out of a road range based on geographic information from among all the received GPS coordinates.

For example, when a car moves along a riverside road, if coordinates are collected as moving along a river or a nearby mountain instead of a road, the corresponding coordinates are excluded.

In addition, the control server 200 performs an operation of excluding the coordinates that are out of the a predetermined range by applying a regression analysis model to all the received GPS coordinates, and thus, when the coordinates are significantly out of an error range in which a vehicle may drive due to a shaded area or momentary communication failure, the control server 200 excludes the corresponding coordinates. In addition, according to an embodiment, the control server 200 may be configured to perform an operation of applying a predetermined machine learning model to all the received GPS coordinates to classify coordinates that are out of the predetermined range.

That is, in the embodiment,
Step 1: Acquire GPS 1 (10,000), GPS 2 (5,000) multi-GPS information,
Step 2: GPS integration (vehicle-based time sequence alignment) <10,000+5,000=15,000>,
Step 3: Apply GPS information simplification algorithm to optimize GPS (vehicle-based time sequence alignment, 3,000), thereby improving accuracy while simplifying coordinates.

Referring to the flowchart of the method for improving multi-GPS accuracy processed in the vehicle control management system for improving multi-GPS accuracy of the present disclosure of FIG. 3 and the flowchart of the method for improving multi-GPS accuracy according to the embodiment of FIG. 4,
the control server 200 processes a step (S10) of receiving each GPS coordinate from multiple GPS terminals. That is, the accuracy is improved by simultaneously acquiring location information from multiple devices such as smartphones, vehicle navigation terminals, and vehicle black box terminals.

Next, a step (S2) of aligning all the received GPS coordinates in the vehicle-based time sequence, but excluding the GPS coordinates that are out of the predetermined range is performed.

That is, the coordinates that are out of the road range based on the geographic information are excluded from among all the received GPS coordinates, or the coordinates that are out of the predetermined range are excluded by applying the regression analysis model to all the received GPS coordinates, thereby preventing coordinate errors due to a GPS shaded area, a communication shaded area, other radio interference, etc.

Finally, a simplification step (S30) of simplifying the GPS coordinates by applying a preset GPS information simplification algorithm is processed.

In an embodiment of the present disclosure, as the GPS information simplification algorithm, “Ramer-Douglas-Peucker algorithm” as the first algorithm and “LANG” as the second algorithm may be selectively used.

The first algorithm or the second algorithm may be applied simultaneously and then selectively used based on the statistical accuracy determination of the control server 200, or may be selectively applied based on a preset specific situation.

For reference, the first algorithm, “Ramer-Douglas-Peucker algorithm,” uses a method for recursively dividing a line. At first, all points between the first point (coordinates) and the last point are given. The first and last points to be maintained are automatically marked. Then, the point that is farthest from a line segment with the first and last points as endpoints is found, and this point is always farthest from a curve in an approximate line segment between the endpoints. As the point is closer than a reference distance ε on the line segment, it is possible to select whether to maintain or exclude the point. The reference distance ε may be selected by a user. In other words, the “Ramer-Douglas-Peucker algorithm” is applied to remove coordinates that are out of a predetermined range and reduce the number of coordinates.

The second algorithm “LANG” defines a fixed-size search area, and the first and last points of the corresponding search area form a segment. The segment is used to calculate a vertical distance to each intermediate point. When the calculated distance is greater than a specified tolerance, the search area is reduced by excluding the last point. This process continues until all calculated distances fall below a specified tolerance or there are no more intermediate points. All the intermediate points are removed and a new search area starting from the last point of the previous search area is defined. In other words, the “LANG” is applied to remove coordinates that are out of a predetermined range and reduce the number of coordinates.

Meanwhile, the vehicle control management system 1 of the present disclosure may efficiently process logistics, charging, cargo management, delivery, etc. by applying the preset GPS information simplification algorithm to simplify the GPS coordinates and improve the multi-GPS accuracy.

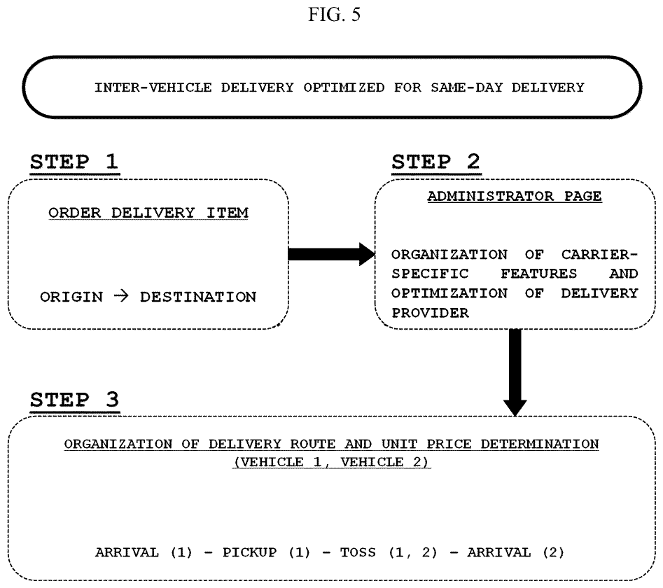

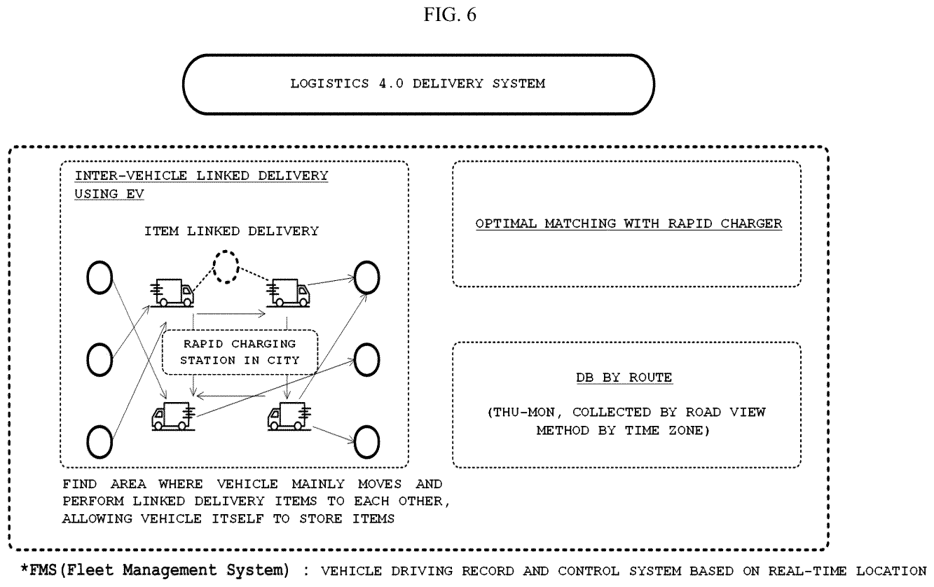

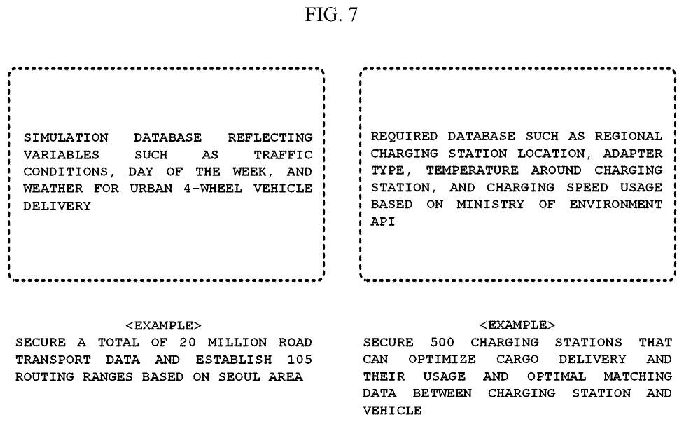

FIG. 5 is an example diagram for managing inter-vehicle linked delivery, FIG. 6 is an exemplary diagram for managing matching between linked delivery and a charger, and FIG. 7 is an exemplary diagram for performing management by reflecting variables such as traffic conditions and weather.

Referring to FIGS. 5 to 7, the vehicle control management system 1 may accurately identify the location information of each vehicle in the control server 200, and then process an operation of providing a specific service to the consumer terminal 300 and the transportation driver terminal 400.

That is, the consumer terminal 300 has a consumer application installed to process the service provided by accessing the control server 200, and the transportation driver terminal 400 has a transportation driver application installed to process the service provided by accessing the control server 200, so these terminals operate to process the logistics, charging, cargo management, delivery, etc., provided by the control server 200.

The consumer terminal 300 and the transportation driver terminal 400 are defined as devices that may be carried and used by the user, such as a mobile phone, a smartphone, and a smart pad.

That is, the vehicle control management system 1 may provide various services after simplifying and improving the accuracy of GPS coordinates by applying the GPS information simplification algorithm, so the reliability of providing charging station information according to the electric vehicle charging status, organizing delivery routes, and determining unit prices may be improved. In addition, by finding an area where vehicles mainly move based on the location accuracy to support the use of the vehicle itself, it is possible to support utilizing the vehicle itself as a storage location for items.

As described above, according to the vehicle control management system of the present disclosure, by collecting the GPS coordinates from the multiple GPS terminals of the vehicle and applying the preset GPS information simplification algorithm to simplify the GPS coordinates, it is possible to improve the multi-GPS accuracy, and efficiently process the logistics, charging, cargo management, delivery, etc.

As described above, it may be understood by those skilled in the art to which the present disclosure pertains that the present disclosure may be implemented as other specific forms without changing the spirit or essential feature thereof. Therefore, it is to be understood that the exemplary embodiments described hereinabove are illustrative rather than being restrictive in all aspects. It is to be understood that the scope of the present disclosure will be defined by the claims rather than the above-mentioned description and all modifications and alternations derived from the claims and their equivalents are included in the scope of the present disclosure.

What is claimed is:

1. A method for improving multi-GPS accuracy, the method comprising:
receiving, by a control server, each GPS coordinate from multiple GPS terminals of a vehicle;
aligning, by the control server, all received GPS coordinates in vehicle-based time sequence, but excluding the GPS coordinates that are out of a predetermined range; and
simplifying, by the control server, the GPS coordinates by applying a preset GPS information simplification algorithm to simplify the GPS coordinates to remove coordinates that are out of the predetermined range and reduce the number of coordinates.

2. The method of claim 1, wherein the GPS information simplification algorithm selectively uses “Ramer-Douglas-Peucker algorithm” as a first algorithm and “LANG” as a second algorithm.

3. The method of claim 1, wherein the multiple GPS terminals include at least one of a smartphone, a vehicle navigation terminal, and a vehicle black box terminal.

4. The method of claim 1, wherein, in the aligning, coordinates that are out of a road range based on geographic information are excluded from among all the received GPS coordinates.

5. The method of claim 1, wherein, in the aligning, the coordinates that are out of the predetermined range are excluded by applying a regression analysis model or machine learning to all the received GPS coordinates.

6. A vehicle control management system collecting operation information of multiple vehicles to control each vehicle, the vehicle control management system comprising:
when collecting operation information of a vehicle, a vehicle information collection unit configured to collect each GPS coordinate from multiple GPS terminals inside the vehicle; and
when receiving the operation information of the vehicle information collection unit through a wireless communication network, a control server configured to:
align all received GPS coordinates in a vehicle-based time sequence, but align the GPS coordinates by excluding GPS coordinates that are out of a predetermined range; and
simplify the GPS coordinates by applying a preset GPS information simplification algorithm.

7. The vehicle control management system of claim 6, further comprising:
a consumer terminal including a consumer application installed for processing a service provided by accessing the control server; and
a transportation driver terminal having a transportation driver application installed for processing the service provided by accessing the control server.

8. The vehicle control management system of claim 6, wherein the GPS information simplification algorithm selectively uses “Ramer-Douglas-Peucker algorithm” as a first algorithm and “LANG” as a second algorithm.

9. The vehicle control management system of claim 6, wherein the multiple GPS terminals s include at least one of a smartphone, a vehicle navigation terminal, and a vehicle black box terminal.

10. The vehicle control management system of claim 6, wherein the control server excludes coordinates that are out of a road range based on geographic information from among all the received GPS coordinates.

11. The vehicle control management system of claim 6, wherein the control server excludes the coordinates that are out of the predetermined range by applying a regression analysis model or machine learning to all the received GPS coordinates.
